(19) United States
(12) Patent Application Publication
(10) Pub. No.: US 2004/0136814 A1
(43) Pub. Date: Jul. 15, 2004

(54) Method and device for transferring baking trays and a load carrier therefore

(76) Inventor: Peter Bastiaan Tromp, EB Arkel (NL)

Correspondence Address: BROOKS KUSHMAN P.C., 1000 TOWN CENTER, TWENTY-SECOND FLOOR, SOUTHFIELD, MI, 48075, US

(21) Appl. No.: 10/345,069

(22) Filed: Jan. 15, 2003

(51) Int. Cl. B65G 1/00

(52) U.S. Cl. 414/331.01

(57) ABSTRACT

The invention relates to a transfer device and a method for transferring baking trays from a load carrier to a transport device, or vice versa. According to the invention a stack of baking trays is transferred integrally into or out of the load carrier. In a stacking magazine the stack is first formed or, conversely, arranged separately after unloading. Owing to the method and the device a load carrier can be emptied or filled more rapidly, and a more efficient manner of working is achieved.

The invention relates to a method for transferring baking trays, comprising of providing baking trays in mobile load carriers, supporting a stack of baking trays which is formed by a number of baking trays held vertically at a predetermined distance above each other, and receiving the stack of baking trays in the load carrier. The invention also relates to a transfer device and a load carrier.

It is known from DE 198 03 143-A1 to receive baking trays in a load carrier by arranging the baking trays in the load carrier, moving the baking trays with a lifting device through the load carrier and then supporting the tray. The baking tray is herein supported by swivelling carrier means, which are arranged on the frame of the load carrier and which engage on the underside of the baking tray when the lifting device moves downward.

The known method has the drawback that the lifting device positions the baking trays in the load carrier one by one. The baking trays are placed on the swivelling carrier means which are situated at a predetermined distance above each other in the load carrier.

The object of the invention is to provide a method for transferring baking plates, wherein the transfer of the baking plates in or out of the load carrier can take place more rapidly.

According to the invention this object is achieved by providing a stacking magazine, receiving the stack of baking trays in the stacking magazine, positioning the load carrier relative to the stacking magazine and transferring the stack in a single operation by guiding the baking trays in a transfer device between the load carrier and the stacking magazine. The load carrier is hereby filled or emptied in a single operation. The stack of baking trays is processed substantially as one whole during this method. This produces a more efficient method, since after the transfer the load carrier is replaced by a subsequent one while the baking trays are being processed in the stacking magazine, for instance are being placed separately on a conveyer track. On the other hand, individual baking trays can also be fed and pre-stacked in the stacking magazine while the empty load carrier is being placed in position relative to the stacking magazine. The stack is preferably guided substantially horizontally.

It is advantageous according to the invention to guide the load carrier to a position such that the load carrier co-acts with the stacking magazine. The position of the load carrier relative to the stacking magazine is hereby determined and transfer takes place in automated manner. It is also possible to guide the load carrier to its position without human intervention. After the transfer the load carrier can be moved out of the position and a subsequent load carrier can be placed at the transfer position.

In a preferred embodiment the stack of baking trays is pushed substantially in a transfer direction during the transfer. A number of baking trays can hereby be set into motion simultaneously and guided in the transfer direction between the stacking magazine and the load carrier. It is possible to transfer a stack of baking trays with one pusher.

In a further preferred embodiment the stack in the stacking magazine is formed by repeating the guiding of one baking tray at a time into the stacking magazine, supporting the baking tray and subsequently moving the baking tray substantially vertically. Individual baking trays which are fed on a conveyor track to the stacking magazine can hereby be received in a stack. While the stack is being formed, or during the ‘pre-stacking’, the position of the load carrier for filling is not yet important, and time is gained. The substantially vertical movement preferably corresponds with the predetermined mutual distance in the stack of baking trays. The mutual distances of the stack formed in the stacking magazine correspond to the mutual distances of the baking trays in the load carrier.

During formation of the stack the vertical movement is preferably carried out intermittently. This creates time to guide the baking tray into the stacking magazine, wherein the stack is held still. The moment no baking tray is being guided into the stacking magazine, the formed stack moves upward.

The above can also be carried out in reverse. It is hereby possible to convert a stack of baking trays into baking trays placed successively on a conveyor track. The baking trays of the stack of baking trays transferred into the stacking magazine are discharged separately one after another.

In a preferred embodiment the baking tray is supported on the underside. The support can hereby also be used as guide over which the baking tray can move.

In a further preferred embodiment the baking tray is supported at least at two positions spaced apart at a pre-determined distance. The baking trays in the stack are hereby supported by two spaced-apart contact surfaces, between which a space is present which can for instance be used to push the full stack in a single operation during the transfer.

The invention also relates to a transfer device for baking trays, comprising a frame provided with a transport device for baking trays, with positioning means for positioning at least one mobile load carrier relative to the transfer device such that baking trays can be transferred into or out of the load carrier, wherein the load carrier comprises support means for a stack of baking trays, wherein the baking trays are arranged at a predetermined distance above one another, and drive means and guide means arranged on the frame which can transfer baking trays between a load carrier co-acting with the positioning means and the transport device. According to the invention the transfer device is provided with at least one stacking magazine for supporting a stack of baking trays at the predetermined distance above one another, and with transfer means for transferring the stack of baking trays in a single operation between the positioned load carrier and the stacking magazine. A transfer device is hereby provided which can transfer baking trays in and/or out of a load carrier in efficient manner, because substantially the whole stack of baking trays is displaced in a single operation in or out a load carrier. After the transfer the stack can be further processed, while the load carrier is replaced.

The guide means and/or the support means preferably comprise a contact surface which can engage on the underside of baking trays. Use is hereby made of the possible co-action of the contact surface and the baking tray, which can move over each other. These means are preferably horizontal.

At least two contact surfaces are preferably arranged at a mutual distance transversely of a direction of movement of the baking trays. Thus created between the contact surfaces is a free space through which for instance the transfer means can move. The space where a stack can be formed therefore comprises standing side walls on which are arranged contact surfaces which support the baking trays.

It is advantageous when the transfer means comprise at least one arm which is movable in a transfer direction and can engage on the stack of baking trays. The arm can hereby engage on the stack of baking trays and transfer them. Driving of the individual baking trays hereby becomes unnecessary.

In a preferred embodiment the arm comprises a substantially vertical surface. The stack of baking trays is pushed herewith.

According to a further preferred embodiment the arm is movable between the contact surfaces arranged at a mutual distance. The arm moves through the free space formed between the contact surfaces. The stack of baking trays can hereby be displaced in a transfer direction with one arm, whereby separate drives for each baking tray in the stack of baking trays become unnecessary.

The stacking magazine preferably comprises at least one endless belt, a part of which is arranged on the frame for movement substantially in vertical direction, and wherein the belt is provided with a number of carrying means for baking trays spaced apart at the predetermined mutual distance. Baking trays can hereby be stacked on the carrying means at a determined mutual distance. A baking tray arranged on a carrying means is moved in vertical direction by moving the part of the belt upward/downward, for instance with a suitable drive. A subsequent baking tray can hereby be arranged on a subsequent carrying means. The endless belt is for instance arranged on the frame by means of a bearing. Two endless belts are preferably arranged, each provided with carrying means for baking trays. The belt is driven with a drive means.

The positioning means preferably comprise a guide for a load carrier, which can guide the load carrier to a position in which the load carrier co-acts with the stacking magazine. The load carrier can hereby be placed automatically into a position co-acting with the stacking magazine, whereby the transfer is automated. After the transferring action the load carrier is taken out of the co-acting position and moved further.

Preferably arranged on the guide are movable co-displacing elements which can engage on the load carrier. The load carrier is hereby moved along the guide.

The invention also relates to a load carrier, comprising a frame, at least two series of support means for baking trays arranged at a mutual distance on the frame and placed at a predetermined distance above one another, and moving means arranged on the frame. The load carrier is characterized in that it is evidently intended for use according to the invention as described above.

It is noted that it is known from DE 100 47 692-A1 to transfer dough products on conveyor belts from a load carrier onto a second conveyor belt, wherein a number of layers of the dough products are transferred simultaneously from the load carrier. Not known herefrom however is the use of baking trays and that emptying of substantially the whole load carrier in a single operation can result in accelerated processing of dough products.

The invention will be further described with reference to the annexed drawings, in which:

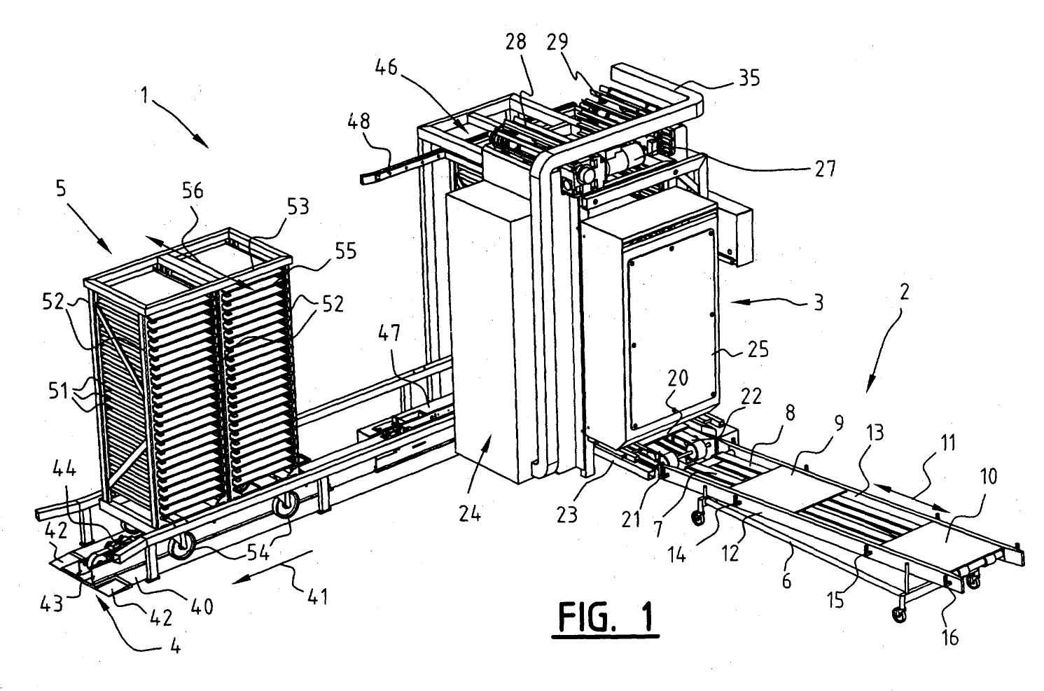

FIG. 1 shows a perspective view of a first embodiment of a transfer device according to the invention for filling a load carrier,

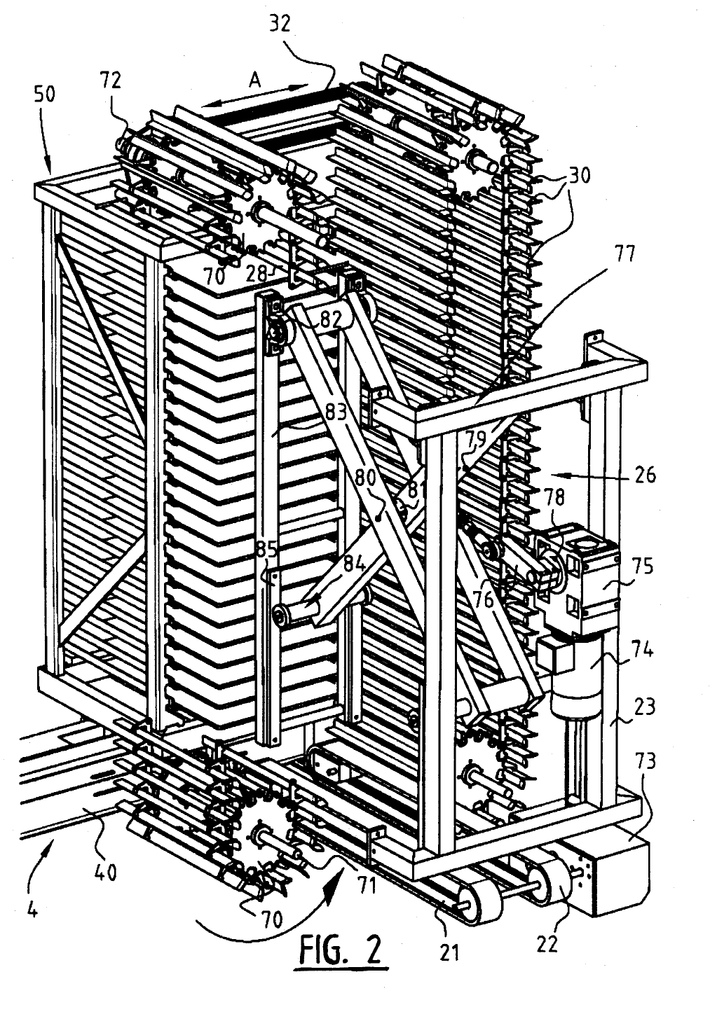

FIG. 2 shows a partially cut-away detail view, with omissions, of the transfer out of the stacking magazine of FIG. 1 into the load carrier, and

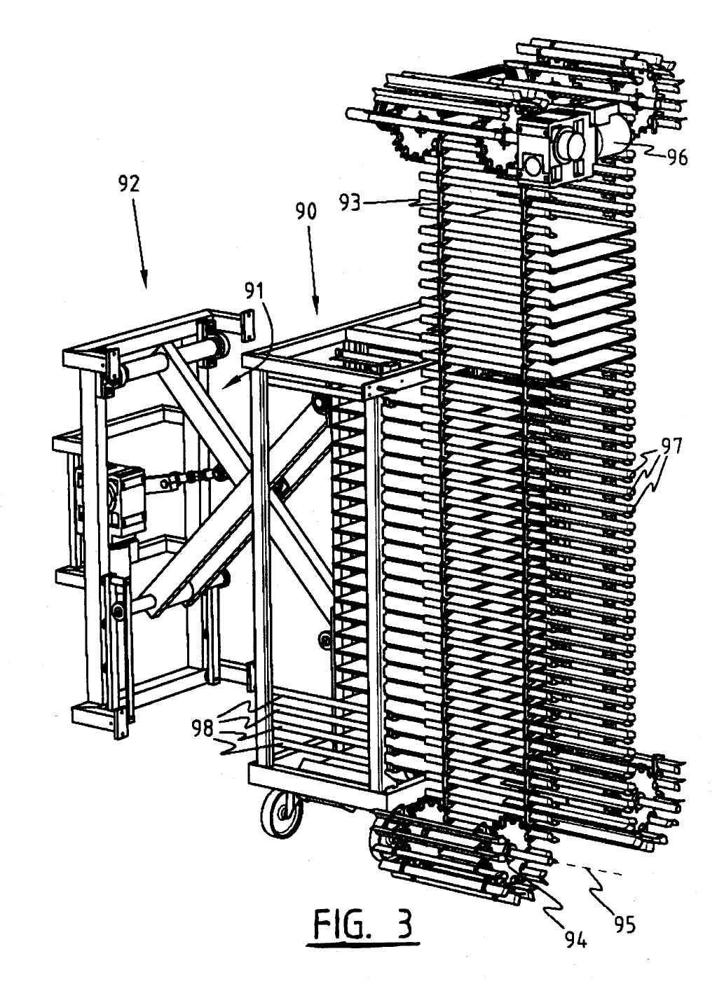

FIG. 3 shows a perspective detail view of a second embodiment of a transfer device according to the invention.

FIG. 1 shows a transfer device 1 comprising a transport device 2, a stacking magazine 3, a guide 4 for mobile load carrier 5.

Transport device 2 comprises a frame 6 which is known from the prior art, having two endless belts 7 and 8 bearing-mounted thereon for the transport of baking trays 9, 10. Baking trays 9, 10 are substantially rectangular and can be displaced over transport device 2 by a drive (not shown) which sets belts 7, 8 into motion as according to arrow 11.

Situated on both sides of the baking trays 9, 10 are standing side walls 12, 13 which ensure that baking trays 9, 10 are guided over transport device 2. The distance between side walls 12, 13 is adjusted on the basis of the width of the baking trays. Side wall 12 is connected to frame 6 by means of adjusting means 14, 15, 16.

Baking tray 20 is moved from the transport device 2 in the direction of stacking magazine 3 and is supported on the underside by a second set of endless conveyor belts 21, 22 which are bearing mounted on the frame 23 of stacking magazine 3. The endless belts 21, 22 define a substantially horizontal part, on which the baking tray 20 in FIG. 1 is situated. Transporting cords can be used instead of belts.

Stacking magazine 3 comprises a frame 23 having arranged thereon a control cabinet 24 and a frame part 25 with the transfer means 26 arranged therein, see FIG. 2.

Also arranged on the frame is a drive 27 for the endless belts 28, 29 which are mounted on frame 23 and each provided with a number of carrying means 30 arranged at predetermined mutual distances with contact surfaces in the form of an L-shaped profile 30. The two endless belts 28, 29 lying opposite each other have two substantially vertical parts, wherein the respective L-shaped profiles 30 lie opposite each other and between which there is a free space 31. The width A of the free space 31 is substantially the same as the width of baking tray 20. The endless belts 28, 29 are mutually connected by means of a third belt 32 and a transmission (not shown) such that the opposite parts of endless belts 28, 29 move up and downward synchronously in accordance with the drive 27.

The L-shaped profile 30 is a guide means and a support means for a baking tray 20 which is guided into the stacking magazine over belts 21, 22. The drive 27 will move the belts intermittently upward, whereby a baking tray introduced into stacking magazine 20 will be supported and carried upward by L-shaped profile 30. The feed of transport device 1 and the speed of the vertical movement are adjusted to each other such that the baking tray introduced into stacking magazine 20 is moved upward a predetermined distance at a time, before a subsequent baking tray is introduced. In this manner a stack of baking trays is created which is received in the stacking magazine.

In reverse manner the drive 27 can actuate the endless belts 28 and 29 such that the baking trays received between the opposite carrying means are moved downward, where they are supported by the conveyor belts 21, 22 and subsequently discharged. In this manner a stack of baking trays can be individualized into baking trays transported separately one after another.

The control cabinet 24 comprises a control device (not shown) which is connected to the drives for the respective parts of transfer device 1. Control cabinet 24 is connected for this purpose to the cable duct device 35, in which electronic connections are received which connect the control device to the respective drives.

The guide 4 is formed by a frame 40 onto which a mobile load carrier 5 can be moved. The load carrier 5 is fed in as according to arrow 41. Frame 40 further comprises standing side walls 42 and a standing central part 43 between which and over which the load carrier can be moved. Load carrier 5 is engaged by co-displacing elements 44 which are arranged on an endless belt and which protrude above the standing part 43 and can engage on the underside of load carrier 5. A hook is for instance arranged on the underside. The movement of co-displacing element 44 will pull the load carrier along as according to arrow 41 over the guide track 4.

Use can be made of a co-displacing element 44 which can determine the position of load carrier 5 on guide 4 with high precision. The choice of a good co-displacing element will be known to the person skilled in the art.

Load carrier 5 moves as according to arrow 41. The shown load carrier 5 is already filled with baking plates. The load carrier comes from the filling position 46 located in the part situated behind stacking magazine 3 in FIG. 1.

A load carrier 5 is brought into and held in a position by means of positioning means 47 and an additional guide 48, wherein the transfer of the baking trays from stacking magazine 3 is possible. Positioning means 47 engage on load carrier 5 and ensure a precise positioning of the load carrier relative to stacking magazine 3. In the filling position the load carrier 5 co-acts with stacking magazine 3.

In the embodiment according to FIG. 1 the load carrier 5 is formed by three standing frame parts 52 and a transverse part 53. The load carrier is provided with four moving means in the form of wheels 54.

Frame parts 52 are provided with L-shaped support means 51 for baking trays 55. Baking tray 55 is supported on the underside. Baking tray 55 is supported on both sides by a contact surface which extends over a relatively small portion of baking tray 55. Two stacks of baking trays are received adjacently of each other in load carrier 5. Baking trays 55 are situated at predetermined distances above each other. The support means are also guide means over which the baking trays can slide. Baking trays can be slid in the direction of arrow 56.

An unfilled load carrier substantially defines two open spaces in the direction of arrow 56.

The transfer of a stack of baking trays will now be discussed in more detail.

FIG. 2 shows the internal parts of stacking magazine 3. A large number of elements are omitted in FIG. 2 in order to be able to show the necessary details.

The right-hand endless belt 28 is partially omitted. The linkage belt is trained around two wheels 70 which are bearing-mounted on frame 23 for rotation around shaft 71 and shaft 72. Belt 28 is provided at regular intervals with a large number of L-shaped profiles 30 which are spaced apart at a predetermined distance.

The opposite, substantially vertical parts of endless belts 28, 29 have in each case two contact surfaces 30 which lie substantially in a horizontal plane and on which a baking tray can be arranged.

By supplying one baking tray at a time over belts 21,22 and intermittently moving upward the contact surfaces lying opposite each other, one baking tray at a time is engaged on two sides, supported and moved upward, whereby a stack of a number of baking trays finally results. Belts 21,22 are actuated by means of drive 73, which drive is connected to the control device.

Load carrier 50 is guided over guide 4 and positioned opposite stacking magazine 3. Load carrier 50 is provided with a series of support means or guide means for baking trays so that the load carrier can receive a stack of baking trays.

Guide 4 and stacking magazine 3 can co-act such that a stack of baking trays formed between belts 28,29 is formed by baking plates which lie above each other at substantially the same predetermined mutual distance, and that the respective support means 51 of load carrier 50 and of stacking magazine 3 are situated at substantially the same height.

It is hereby possible to transfer the stack in a single operation with the transfer means 26, in the embodiment of FIG. 2 a pushing arm. The situation shown in FIG. 2 shows the method during the transfer. The transfer device is indicated by arrow 86.

Transfer means 26 are formed in FIG. 2 by a drive 74 arranged on the frame, a transmission 75 provided with an arm 76 which engages pivotally on a scissor means 77. Drive 74 causes arm 76 to move according to arrow 78.

According to FIG. 2, scissor means or linkage mechanism 77 comprises an arm 79 mounted on frame 23 and an arm 80 guided along the frame, which arms 79,80 are mutually connected substantially in the centre by means of a bearing 81. This results in a linked motion with crossed rods.

On the end remote from the frame the arm 80 is provided with a bearing 82, which is connected to a substantially vertical surface 83 formed by two arms connected transversely to each other. Arm 79 comprises guide means 84 which can be guided as according to arrow 85 along the rear side of the arms of the vertical surface, for instance as a result of the movement of arm 76.

The link motioned mean is a pusher. It pushes the stack of baking trays out of the stacking magazine into load carrier 50 in a single operation.

FIG. 3 shows a second embodiment, wherein a stack of baking trays is transferred from a load carrier 90 with the same construction as the above shown load carriers. Linked motion means 90 of transfer means 92 is now arranged outside the stacking magazine (not shown), so that when driven the stack of baking trays is pushed out of the load carrier and comes to lie in the stacking magazine.

Of the stacking magazine are shown only the endless belts 93 with support means for the baking trays which are mounted around wheels 94 and shaft 95 and driven with motor 96. The belts are partially omitted.

The support means 97 lie at the same height as support means 98. The support means in load carrier 90 are partially omitted. The stack of baking trays is transferred in guided manner in transfer device 87.

Not shown is that products, for instance dough products, are arranged on the baking trays. The load carriers 5,50 are for instance suitable for placing integrally into an oven. Products arranged on a baking tray, for instance pizzas, can thus be baked.

It is possible to arrange two stacking magazines adjacently of each other so that a load carrier 5 with two stacks of baking trays can be filled or emptied in a single operation.

Although the appended claims can be interpreted as including those embodiments specifically described above, other embodiments and all equivalents thereof will also fall within the scope of the invention. Other embodiments will be apparent to the skilled person.

1. Method for transferring baking trays, comprising of:
providing baking trays (9,10) and mobile load carriers (5,90),
supporting a stack of baking trays (55) which is formed by a number of baking trays held vertically at a predetermined distance above each other, and
receiving the stack of baking trays in the load carrier (5,90), characterized by
providing a stacking magazine (3),
receiving the stack of baking trays in the stacking magazine (3),
positioning the load carrier (5,90) relative to the stacking magazine (3), and
transferring the stack in a single operation by guiding the baking trays in a transfer device (86,87) between the load carrier (5,90) and the stacking magazine (3).

2. Method as claimed in claim 1, characterized by guiding the load carrier (5) to a position such that the load carrier can co-act with the stacking magazine (3).

3. Method as claimed in claim 1, characterized by pushing the stack substantially in a transfer direction (86) during the transfer.

4. Method as claimed in claim 1, characterized by forming the stack in the stacking magazine (3) by repeating the guiding of a baking tray (12) into the stacking magazine, supporting the baking tray and subsequently moving the baking tray substantially vertically.

5. Method as claimed in claim 4, characterized by intermittent vertical movement.

6. Method as claimed in claim 1, characterized by supporting the baking tray (12) on the underside of the baking tray.

7. Method as claimed in claim 1, characterized by supporting the baking tray at least at two spaced apart at a per-determined distance positions.

8. Transfer device for baking trays, comprising a frame (23) provided
with a transport device (2) for baking trays (9,10),
with positioning means (47,48) for positioning at least one mobile load carrier (5) relative to the transfer device (1) such that baking trays can be transferred into or out of the load carrier (5), wherein the load carrier comprises support means (51) for a stack of baking trays, wherein the baking trays (55) are arranged at a predetermined distance above one another, and
drive means (27) and guide means (30) arranged on the frame which can transfer baking trays (9,10,12) between a load carrier (5) co-acting with the positioning means (47,48) and the transport device (2),
characterized in that the transfer device (1) is provided
with at least one stacking magazine (3) for supporting a stack of baking trays at the predetermined distance above one another, and
with transfer means (26) for transferring the stack of baking trays in a single operation between the positioned load carrier (5) and the stacking magazine (3).

9. Transfer device as claimed in claim 8, characterized in that the guide means (30) and/or the support means (51) comprise a contact surface which can engage on the underside of the baking trays (9,10,12).

10. Transfer device as claimed in claim 9, characterized in that at least two contact surfaces are arranged at a mutual distance transversely of a direction of movement (86,87) of the baking trays.

11. Transfer device as claimed in claim 8, characterized in that the transfer means (26) comprise at least one arm (79) which is movable in the direction of transfer (86,87) and can engage on the stack of baking trays.

12. Transfer device as claimed in claim 11, characterized in that the arm (79) comprises a substantially vertical surface (83).

13. Transfer device as claimed in claim 10, characterized in that the arm (79) is movable between the contact surfaces arranged at a mutual distance.

14. Transfer device as claimed in claim 8, characterized in that the stacking magazine (3) comprises at least one endless belt (28,29), a part of which is arranged for movement substantially in vertical direction, and wherein the belt (28,29) is provided with a number of carrying means (30) for baking trays spaced apart at the predetermined mutual distance.

15. Transfer device as claimed in claim 8, characterized in that the positioning means (47,48) comprise a guide (4) for a load carrier (5), which can guide the load carrier (5) to a position in which the load carrier (5) co-acts with the stacking magazine (3).

16. Transfer device as claimed in claim 15, characterized in that the guide (4) is provided with movable co-displacing elements (44) which can engage on the load carrier (5).

17. Load carrier, comprising a frame, at least two series of carrying means (51) for baking trays arranged at a mutual distance on the frame and placed at a predetermined distance above one another, and moving means (54) arranged on the frame, characterized in that the load carrier is evidently intended for use as claimed in any of the foregoing claims.
